(19) United States
(12) Patent Application Publication
(10) Pub. No.: US 2026/0321084 A1
(43) Pub. Date: Oct. 15, 2026

(54) CASH RECYCLING APPARATUS AND BANKNOTE PROCESSING METHOD

(71) Applicant: SHANDONG NEW BEIYANG INFORMATION TECHNOLOGY CO., LTD., Shandong (CN)

(72) Inventors: Zhenxing ZHAO, Shandong (CN); Tao GAO, Shandong (CN); Chuntao WANG, Shandong (CN); Bingqing LIU, Shandong (CN); Tianxin JIANG, Shandong (CN)

(21) Appl. No.: 19/481,963

(22) PCT Filed: May 7, 2024
(86) PCT No.: PCT/CN2024/091309

§ 371 Date: Nov. 6, 2025

(30) Foreign Application Priority Data
May 8, 2023 (CN) 202310510496.6

(51) Int. Cl. G07D 11/13; G07D 11/18

(52) U.S. Cl. CPC G07D 11/13; G07D 11/18

(57) ABSTRACT

A cash recycling apparatus includes an upper conveying channel, a lower conveying channel, a banknote feeding device, a banknote discharging device, a banknote recognition device, a first intermediate channel, a second intermediate channel, and multiple banknote boxes. The banknote feeding device and the banknote discharging device are connected to the upper conveying channel. The banknote recognition device is disposed on the upper conveying channel. Each banknote box is connected to the lower conveying channel. The first intermediate channel and the second intermediate channel are independent of each other and are both connected between the upper conveying channel and the lower conveying channel. The first intermediate channel is configured to convey banknotes from the upper conveying channel to the lower conveying channel. The second intermediate channel is configured to convey banknotes from the lower conveying channel to the upper conveying channel.

### CROSS-REFERENCE TO RELATED APPLICATION(S)

This application is a U.S. National Stage Application filed under 37 U.S.C. 371 based on International Patent Application No. PCT/CN2024/091309, filed May 7, 2024, which claims priority to Chinese Patent Application No. 202310510496.6 filed with the China National Intellectual Property Administration (CNIPA) on May 8, 2023, the disclosures of which are incorporated herein by reference in their entireties.

### TECHNICAL FIELD

The present application relates to the technical field of financial self-service apparatuses, for example, a cash recycling apparatus and a banknote processing method.

### BACKGROUND

The Chinese Patent CN218159162U provides a cash recycling apparatus. The cash recycling apparatus includes an upper conveying channel, a banknote reading mechanism, a lower conveying channel, multiple banknote boxes, and an intermediate channel. The upper conveying channel is configured to convey banknotes. The banknote reading mechanism is disposed on the upper conveying channel and is configured to acquire information about the banknotes conveyed in the upper conveying channel. The lower conveying channel is also configured to convey banknotes and communicates with the multiple banknote boxes. The intermediate channel is connected between the upper conveying channel and the lower conveying channel. In the cash recycling apparatus, the banknotes can be conveyed from the upper conveying channel to the lower conveying channel through the intermediate channel, and can also be conveyed from the lower conveying channel to the upper conveying channel through the intermediate channel. The banknotes are conveyed in two opposite directions in the intermediate channel, which leads to a high risk of a banknote jam in the intermediate channel.

### SUMMARY

The present application provides a cash recycling apparatus and a banknote processing method to lower the risk of a banknote jam in intermediate channels.

The present application provides a cash recycling apparatus. The cash recycling apparatus includes an upper conveying channel, a lower conveying channel, a banknote feeding device, a banknote discharging device, a banknote recognition device, multiple banknote boxes, a first intermediate channel, and a second intermediate channel.

The banknote feeding device and the banknote discharging device are connected to the upper conveying channel, the banknote feeding device is configured to feed banknotes into the upper conveying channel, the banknote discharging device is configured to receive banknotes output from the upper conveying channel, the banknote recognition device is disposed on the upper conveying channel and is configured to acquire information about banknotes in the upper conveying channel, and each of the multiple banknote boxes is connected to the lower conveying channel.

The first intermediate channel and the second intermediate channel are independent of each other and are both connected between the upper conveying channel and the lower conveying channel, the first intermediate channel is configured to convey banknotes from the upper conveying channel to the lower conveying channel, and the second intermediate channel is configured to convey banknotes from the lower conveying channel to the upper conveying channel.

The present application further provides a banknote processing method. The method is applied to the cash recycling apparatus in the preceding solution and includes the steps below.

A withdrawal instruction is acquired, where the withdrawal instruction includes a first withdrawal instruction and a second withdrawal instruction.

A first withdrawal operation is performed in a case where the withdrawal instruction is the first withdrawal instruction; and a second withdrawal operation is performed in a case where the withdrawal instruction is the second withdrawal instruction.

The first withdrawal operation includes: conveying banknotes in a recycling box among the multiple banknote boxes to the banknote discharging device sequentially through the lower conveying channel, the second intermediate channel, the third channel, the second channel, and the banknote discharging channel.

The second withdrawal operation includes: conveying banknotes in the recycling box to the banknote recognition device sequentially through the lower conveying channel, the second intermediate channel, the third channel, and the first channel; recognizing banknotes through the banknote recognition device; in a case where banknotes are recognized as qualified banknotes, conveying the qualified banknotes to the banknote discharging device sequentially through the first channel and the banknote discharging channel; and in a case where banknotes are recognized as unqualified banknotes, conveying the unqualified banknotes to a storage box among the multiple banknote boxes sequentially through the first channel, the banknote discharging channel, the first intermediate channel, and the lower conveying channel.

The present application further provides a banknote processing method. The method is applied to the cash recycling apparatus in the preceding solution and includes the steps below.

A withdrawal instruction is acquired, where the withdrawal instruction includes a first withdrawal instruction and a second withdrawal instruction.

A first withdrawal operation is performed in a case where the withdrawal instruction is the first withdrawal instruction; and a second withdrawal operation is performed in a case where the withdrawal instruction is the second withdrawal instruction.

The first withdrawal operation includes: conveying banknotes in a recycling box among the multiple banknote boxes to the banknote discharging device sequentially through the lower conveying channel, the second intermediate channel, the third channel, the second channel, and the banknote discharging channel.

The second withdrawal operation includes: conveying banknotes in the recycling box to the banknote recognition device sequentially through the lower conveying channel, the second intermediate channel, the third channel, the second channel, and the first channel; recognizing banknotes through the banknote recognition device; in a case where banknotes are recognized as qualified banknotes, conveying the qualified banknotes to the banknote discharging device sequentially through the first channel, the third channel, the transition channel, the second channel, and the banknote discharging channel; and in a case where banknotes are recognized as unqualified banknotes, conveying the unqualified banknotes to a storage box among the multiple banknote boxes sequentially through the first channel, the third channel, the transition channel, the second channel, the first intermediate channel, and the lower conveying channel.

### BRIEF DESCRIPTION OF DRAWINGS

FIG. 1 is a diagram illustrating the structure of a cash recycling apparatus according to embodiment one of the present application.

FIG. 2 is a diagram illustrating that banknotes pass through a banknote recognition device during a withdrawal operation of a cash recycling apparatus according to embodiment one of the present application.

FIG. 3 is a diagram illustrating that banknotes do not pass through a banknote recognition device during a withdrawal operation of a cash recycling apparatus according to embodiment one of the present application.

FIG. 4 is a diagram illustrating a deposit operation of a cash recycling apparatus according to embodiment one of the present application.

FIG. 5 is a diagram illustrating single-denomination loading of a cash recycling apparatus according to embodiment one of the present application.

FIG. 6 is a diagram illustrating mixed-denomination loading of a cash recycling apparatus according to embodiment one of the present application.

FIG. 7 is a diagram illustrating that banknotes pass through a banknote recognition device during a clearing operation of a cash recycling apparatus according to embodiment one of the present application.

FIG. 8 is a diagram illustrating that banknotes do not pass through a banknote recognition device during a clearing operation of a cash recycling apparatus according to embodiment one of the present application.

FIG. 9 is an enlarged view of part A in FIG. 1.

FIG. 10 is a diagram illustrating the structure of a cash recycling apparatus according to embodiment two of the present application.

FIG. 11 is a diagram illustrating that banknotes pass through a banknote recognition device during a withdrawal operation of a cash recycling apparatus according to embodiment two of the present application.

FIG. 12 is a diagram illustrating that banknotes do not pass through a banknote recognition device during a withdrawal operation of a cash recycling apparatus according to embodiment two of the present application.

FIG. 13 is a diagram illustrating a deposit operation of a cash recycling apparatus according to embodiment two of the present application.

FIG. 14 is a diagram illustrating mixed-denomination loading of a cash recycling apparatus according to embodiment two of the present application.

FIG. 15 is a diagram illustrating single-denomination loading of a cash recycling apparatus according to embodiment two of the present application.

FIG. 16 is a diagram illustrating that banknotes pass through a banknote recognition device during a clearing operation of a cash recycling apparatus according to embodiment two of the present application.

FIG. 17 is a diagram illustrating that banknotes do not pass through a banknote recognition device during a clearing operation of a cash recycling apparatus according to embodiment two of the present application.

FIG. 18 is a flowchart of a banknote processing method according to embodiment one of the present application.

FIG. 19 is a flowchart of a banknote processing method according to embodiment two of the present application.

FIG. 20 is a diagram illustrating the layout of channels in a cash recycling apparatus according to embodiment one of the present application.

FIG. 21 is a diagram illustrating the layout of channels in a cash recycling apparatus according to embodiment two of the present application.

### REFERENCE LIST

10 frame
20 upper conveying channel
30 lower conveying channel
40 banknote feeding device
50 banknote discharging device
60 banknote recognition device
701 storage box
702 recycling box
703 loading box
704 counterfeit-banknote box
80 first intermediate channel
90 second intermediate channel
11 banknote discharging channel
12 first channel
13 second channel
14 banknote feeding channel
15 transition channel
16 third channel
21 banknote outlet
22 first receiving portion
23 banknote withdrawal port
31 first common junction point
32 second common junction point
33 first connection point
34 second connection point
35 third connection point
36 third common junction point
37 fourth common junction point
38 fifth common junction point
391 fourth connection point
392 fifth connection point
41 second receiving portion
42 banknote insertion port
43 banknote inlet
51 first commutator
52 second commutator
53 first direction switching member
54 second direction switching member
55 first roller
56 second roller
57 third roller
58 third commutator
61 storage channel
62 fourth channel
63 fifth channel
64 branch channel
71 thickness measuring mechanism
72 scanning mechanism
73 magnetic reading mechanism

### DETAILED DESCRIPTION

Technical solutions of the present application are described below in connection with the drawings.

In the description of the present application, orientations or position relations indicated by terms such as “center”, “above”, “below”, “left”, “right”, “vertical”, “horizontal”, “inside”, “outside” and the like are based on the drawings. These orientations or position relations are intended only to facilitate and simplify the description of the present application, and not to indicate or imply that a referred device or element must have such specific orientations or must be configured or operated in such specific orientations. Thus, these orientations or position relations are not to be construed as limiting the present application. In addition, the terms such as “first” and “second” are used for the purpose of description and are not to be construed as indicating or implying relative importance. Terms “first position” and “second position” are two different positions. Moreover, when a first feature is described as “on”, “above”, or “over” a second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

In the description of the present application, unless otherwise specified and limited, the term “mounted”, “connected to each other”, or “connected” is to be construed in a broad sense, for example, as securely connected, detachably connected, or integrated; mechanically connected or electrically connected; directly connected to each other or indirectly connected to each other via an intermediary; or connected inside two elements. For those of ordinary skill in the art, specific meanings of the preceding terms in the present application may be understood based on specific situations.

Embodiments of the present application are described in detail below. Examples of the embodiments are illustrated in the drawings, where the same or similar reference numerals throughout the drawings represent the same or similar elements or elements having the same or similar functions. The embodiments described below with reference to the drawings are illustrative, are used only for explaining the present application, and are not to be construed as limiting the present application.

### Embodiment One

Embodiment one provides a cash recycling apparatus configured for performing deposit and withdrawal operations.

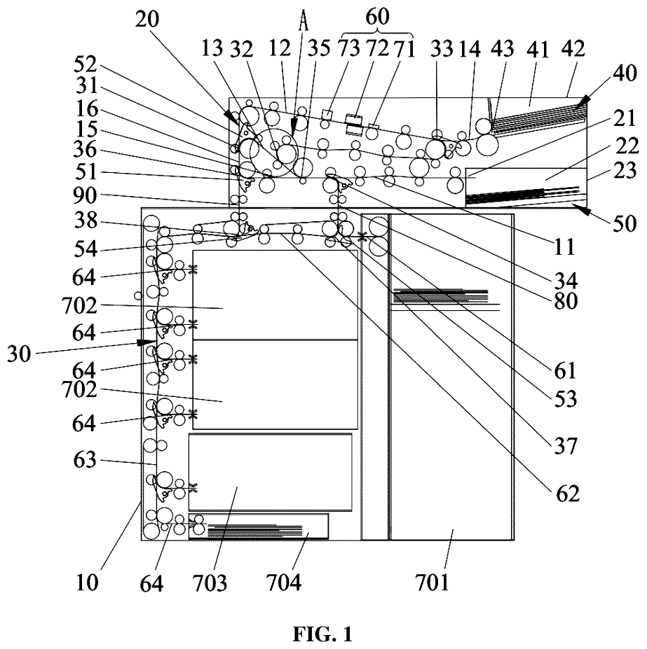

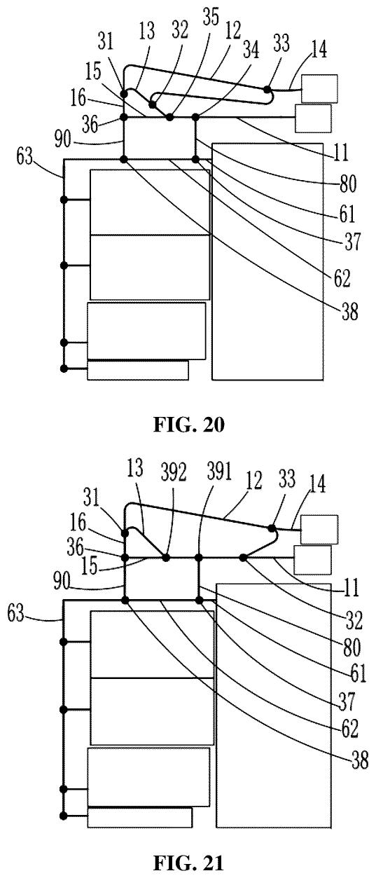

FIG. 1 is a diagram illustrating the structure of a cash recycling apparatus according to embodiment one of the present application. FIG. 20 is a diagram illustrating the layout of channels in a cash recycling apparatus according to embodiment one of the present application. Referring to FIGS. 1 and 20, the cash recycling apparatus includes an upper conveying channel 20, a lower conveying channel 30, a banknote feeding device 40, a banknote discharging device 50, a banknote recognition device 60, a first intermediate channel 80, a second intermediate channel 90, and multiple banknote boxes. The banknote feeding device 40 and the banknote discharging device 50 are connected to the upper conveying channel 20, the banknote feeding device 40 is configured to feed banknotes into the upper conveying channel 20, and the banknote discharging device 50 is configured to receive the banknotes output from the upper conveying channel 20. The banknote recognition device 60 is disposed on the upper conveying channel 20 and is configured to acquire information about the banknotes in the upper conveying channel 20. Each banknote box is connected to the lower conveying channel 30. The first intermediate channel 80 and the second intermediate channel 90 are independent of each other and are both connected between the upper conveying channel 20 and the lower conveying channel 30, the first intermediate channel 80 is configured to convey banknotes from the upper conveying channel 20 to the lower conveying channel 30, and the second intermediate channel 90 is configured to convey banknotes from the lower conveying channel 30 to the upper conveying channel 20. In this manner, the banknotes conveyed from the upper conveying channel 20 to the lower conveying channel 30 pass through the first intermediate channel 80 and the banknotes conveyed from the lower conveying channel 30 to the upper conveying channel 20 pass through the second intermediate channel 90. The banknotes move unidirectionally in both the first intermediate channel 80 and the second intermediate channel 90, thereby lowering the risk of a banknote jam in the first intermediate channel 80 and the second intermediate channel 90.

In this embodiment, the cash recycling apparatus further includes a frame 10. The upper conveying channel 20, the lower conveying channel 30, the banknote feeding device 40, the banknote discharging device 50, the banknote recognition device 60, the first intermediate channel 80, the second intermediate channel 90, and the multiple banknote boxes are disposed on the frame 10. The preceding upper conveying channel 20, lower conveying channel 30, first intermediate channel 80, and second intermediate channel 90 may be formed by conveying rollers and conveying belts. The conveying rollers and conveying belts are driven by a motor to move banknotes in the multiple channels.

Optionally, the cash recycling apparatus further includes a controller (not shown in the figures). The controller is electrically connected to the banknote recognition device 60 and the motor. Referring to FIG. 1, the banknote recognition device 60 includes a thickness measuring mechanism 71, a scanning mechanism 72, and a magnetic reading mechanism 73 that are arranged sequentially along a banknote feeding direction. The thickness measuring mechanism 71 is configured to measure the thickness of a banknote, the scanning mechanism 72 is configured to acquire image information about the banknote, and the magnetic reading mechanism 73 is configured to read magnetic information about the banknote. The thickness measuring mechanism 71, the scanning mechanism 72, and the magnetic reading mechanism 73 transmit the acquired information about the banknote to the controller. Based on the information, the controller determines the authenticity, denomination, and circulation suitability of the banknote, and then controls the motor to operate so that a corresponding channel drives the banknote to move, thereby completing a corresponding operation. Optionally, the banknote feeding device 40 and the banknote discharging device 50 are spaced apart from each other in a vertical direction. In this embodiment, an exemplary solution is provided in which the banknote discharging device 50 is located below the banknote feeding device 40. Optionally, both the first intermediate channel 80 and the second intermediate channel 90 extend in the vertical direction and are spaced apart in a front-rear direction. In other embodiments, the relative positions and extending direction of the first intermediate channel 80 and the second intermediate channel 90 may be set based on practical requirements.

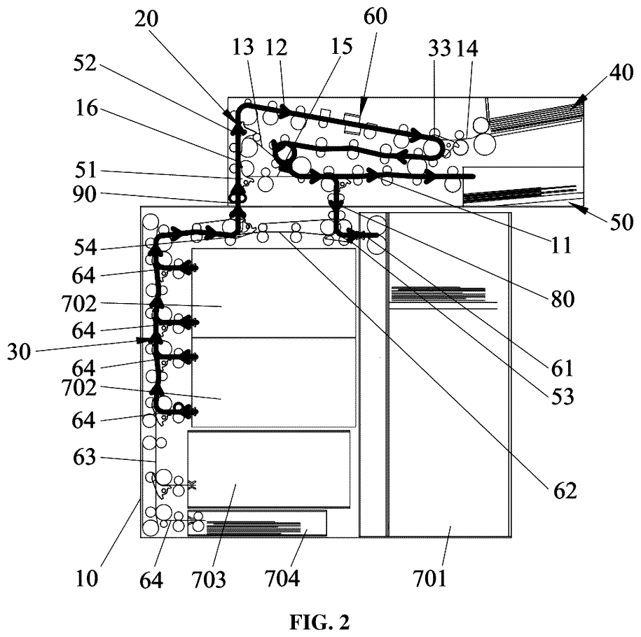

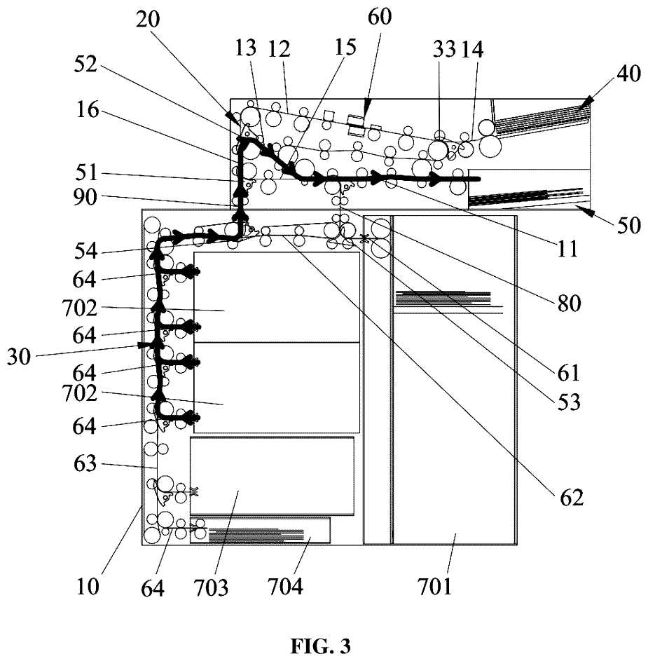

Optionally, referring to FIG. 1, the upper conveying channel 20 includes a banknote discharging channel 11, a first channel 12, and a second channel 13. The banknote discharging channel 11 communicates with the banknote discharging device 50 and can selectively communicate with one of the first channel 12 and the second channel 13, the second intermediate channel 90 can selectively communicate with one of the first channel 12 and the second channel 13, and the banknote recognition device 60 is disposed on the first channel 12. In this manner, during a withdrawal operation, banknotes can either pass through the banknote recognition device 60 before being discharged or be discharged without passing through the banknote recognition device 60, thereby satisfying usage needs of different users. As shown in FIG. 2, in this embodiment, the conveying path of the banknotes passing through the banknote recognition device 60 during a withdrawal operation of the cash recycling apparatus is as follows: the second intermediate channel 90 communicates with the first channel 12, and the banknote discharging channel 11 communicates with the first channel 12; banknotes from a banknote box enter the lower conveying channel 30 and then pass through the second intermediate channel 90 into the first channel 12; after the banknote recognition device 60 recognizes the banknotes, qualified banknotes enter the banknote discharging channel 11 and are directly conveyed to the banknote discharging device 50 from the banknote discharging channel 11, thereby ensuring that the banknotes withdrawn by a user from the banknote discharging device 50 are all qualified. As shown in FIG. 3, in this embodiment, the conveying path of the banknotes that do not pass through the banknote recognition device 60 during a withdrawal operation of the cash recycling apparatus is as follows: the second intermediate channel 90 communicates with the second channel 13, and the banknote discharging channel 11 communicates with the second channel 13; banknotes from the banknote box enter the lower conveying channel 30, are conveyed to the second channel 13 through the second intermediate channel 90, and then directly pass through the banknote discharging channel 11 to the banknote discharging device 50, thereby improving withdrawal efficiency.

Optionally, referring to FIG. 1, the banknote discharging device 50 includes a first receiving portion 22 for stacking banknotes. The first receiving portion 22 is provided with a banknote withdrawal port 23 and a banknote outlet 21. The banknote outlet 21 communicates with the banknote discharging channel 11, allowing banknotes in the banknote discharging channel 11 to enter the first receiving portion 22 through the banknote outlet 21. The user can take out cash from the first receiving portion 22 through the banknote withdrawal port 23.

Optionally, referring to FIGS. 1 and 20, the upper conveying channel 20 further includes a third channel 16. A first end of the third channel 16 is connected to the second intermediate channel 90. A first end of the first channel 12, a first end of the second channel 13, and a second end of the third channel 16 intersect at a first common junction point 31. A second end of the first channel 12, a second end of the second channel 13, and a first end of the banknote discharging channel 11 intersect at a second common junction point 32. A second end of the banknote discharging channel 11 is connected to the banknote discharging device 50. In this manner, the second channel 13 and the first channel 12 are annularly connected, thereby enhancing the compactness of the overall layout of the channels.

In this embodiment, the expression “channel A communicates with channel B” may be understood that banknotes in channel A may directly enter channel B, or that banknotes in channel A may also enter channel B through channel C. In this embodiment, the expression “channel A is connected to channel B” may be understood that channel A and channel B intersect, but there may be a case in which banknotes in channel A cannot enter channel B. For example, a commutator is provided at the junction between channel A and channel B. The commutator is provided with a first position and a second position. When the commutator is located in the first position, the banknotes in channel A can enter channel B through the commutator. When the commutator is located in the second position, the commutator prevents the banknotes in channel A from entering channel B. For another example, channel A, channel B, and channel C intersect, and a commutator is provided at the junction between channel A, channel B, and channel C. The commutator is provided with a first position and a second position. When the commutator is located in the first position, the banknotes in channel A can only enter channel C. When the commutator is located in the second position, the banknotes in channel C can only enter channel B.

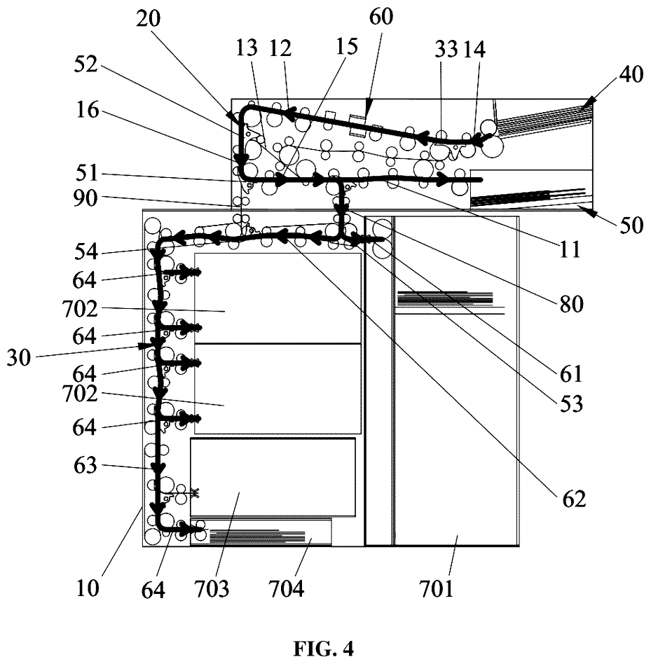

Optionally, referring to FIGS. 1 and 20, the upper conveying channel 20 further includes a banknote feeding channel 14 and a transition channel 15. A first end of the banknote feeding channel 14 is connected to the banknote feeding device 40, and a second end of the banknote feeding channel 14 and the first channel 12 intersect at a first connection point 33. The banknote recognition device 60 is located between the first connection point 33 and the first end of the first channel 12. A first end of the first intermediate channel 80 and the banknote discharging channel 11 intersect at a second connection point 34. A first end of the transition channel 15, the first end of the third channel 16, and the second intermediate channel 90 intersect at a third common junction point 36. A second end of the transition channel 15 and the banknote discharging channel 11 intersect at a third connection point 35 (as shown in FIG. 20). The third connection point 35 is located between the first end of the banknote discharging channel 11 and the second connection point 34. In this manner, during a deposit operation of the cash recycling apparatus provided in this embodiment, as shown in FIG. 4, the banknotes can enter the first channel 12 through the banknote feeding channel 14. The banknote recognition device 60 recognizes the banknotes. Qualified banknotes recognized by the banknote recognition device 60 sequentially pass through the first channel 12, the third channel 16, the transition channel 15, the banknote discharging channel 11, the first intermediate channel 80, and the lower conveying channel 30 into the banknote box. Unqualified banknotes recognized by the banknote recognition device 60 sequentially pass through the first channel 12, the third channel 16, the transition channel 15, and the banknote discharging channel 11 into the banknote discharging device 50. The provision of the transition channel 15 can lower the risk of a banknote jam at the first common junction point 31. During a withdrawal operation of the cash recycling apparatus provided in this embodiment, as shown in FIG. 2, the unqualified banknotes recognized by the banknote recognition device 60 can sequentially pass through the first channel 12, the banknote discharging channel 11, the first intermediate channel 80, and the lower conveying channel 30, and are recycled to the banknote box. In this manner, the unqualified banknotes can be directly recycled instead of being delivered to a customer. In this embodiment, one end of the second intermediate channel 90 communicates with the lower conveying channel 30; the other end of the second intermediate channel 90, the first end of the transition channel 15, and the first end of the third channel 16 intersect. In other embodiments, the third channel 16 and the transition channel 15 are not required. The second intermediate channel 90, the first end of the first channel 12, and the first end of the second channel 13 directly intersect at the first common junction point 31.

Referring to FIG. 1, in this embodiment, the banknote feeding device 40 includes a second receiving portion 41 for stacking banknotes. The second receiving portion 41 is provided with a banknote insertion port 42 and a banknote inlet 43. The user can insert banknotes into the second receiving portion 41 through the banknote insertion port 42. The banknote inlet 43 communicates with the banknote feeding channel 14 so that the banknotes in the second receiving portion 41 can enter the banknote feeding channel 14 through the banknote inlet 43.

Optionally, referring to FIG. 1, the cash recycling apparatus further includes a first commutator 51, and the first commutator 51 is disposed at the third common junction point 36 and is configured to enable the third channel 16 to selectively communicate with one of the transition channel 15 and the second intermediate channel 90; and/or the cash recycling apparatus further includes a second commutator 52, and the second commutator 52 is disposed at the first common junction point 31 and is configured to enable the third channel 16 to selectively communicate with one of the first channel 12 and the second channel 13. In this embodiment, an exemplary solution is provided in which both the first commutator 51 and the second commutator 52 are provided.

Optionally, referring to FIG. 1, the first commutator 51 is rotatably connected to the frame 10 and can rotate relative to the frame 10 and thus has position A1 and position B1. When located in position A1, the first commutator 51 enables the third channel 16 to communicate with the transition channel 15 while blocking the communication between the third channel 16 and the second intermediate channel 90. When located in position B1, the first commutator 51 enables the third channel 16 to communicate with the second intermediate channel 90 while blocking the communication between the third channel 16 and the transition channel 15. The second commutator 52 is rotatably connected to the frame 10 and can rotate relative to the frame 10 and thus has position A2 and position B2. When located in position A2, the second commutator 52 enables the third channel 16 to communicate with the first channel 12 while blocking the communication between the third channel 16 and the second channel 13. When located in position B2, the second commutator 52 enables the third channel 16 to communicate with the second channel 13 while blocking the communication between the third channel 16 and the first channel 12. In other embodiments, the first commutator 51 may be slidably connected to the frame 10, and the second commutator 52 may also be slidably connected to the frame 10.

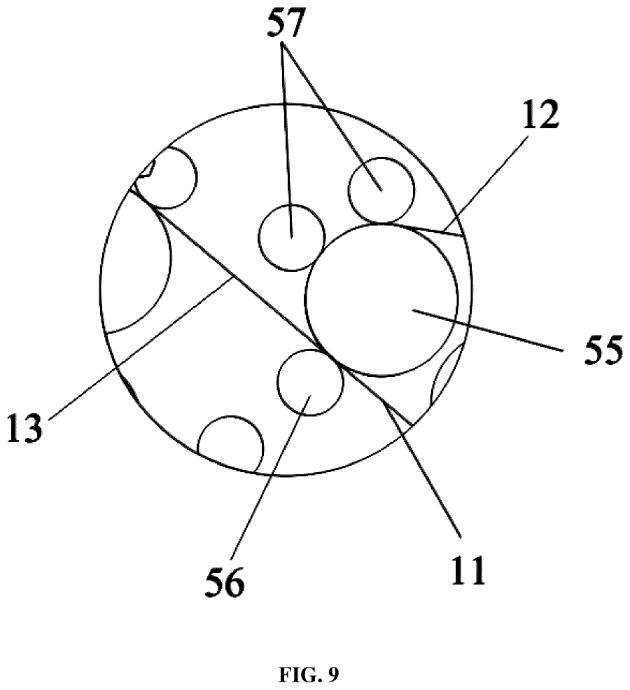

FIG. 9 is an enlarged view of part A in FIG. 1. Optionally, referring to FIG. 9, the upper conveying channel 20 further includes a first roller 55, a second roller 56, and at least one third roller 57. Each third roller 57 is disposed on the first channel 12. The second roller 56 tangentially engages with the first roller 55, and each third roller 57 also tangentially engages with the first roller 55. The first roller 55 and each third roller 57 are configured to convey banknotes in the first channel 12 to the banknote discharging channel 11. The first roller 55 and the second roller 56 are configured to convey the banknotes in the first channel 12 to the banknote discharging channel 11. The first roller 55 and the second roller 56 are further configured to convey banknotes in the second channel 13 to the banknote discharging channel 11. In this embodiment, an exemplary solution is provided in which two third rollers 57 are provided. In other embodiments, the number of third rollers 57 may also be set as needed. In this manner, both the first channel 12 and the second channel 13 communicate with the banknote discharging channel 11. Therefore, both the first channel 12 and the second channel 13 can convey banknotes to the banknote discharging channel 11, eliminating the need for a commutator at the second common junction point 32 and resulting in a simpler structure. In a withdrawal operation of the cash recycling apparatus provided in this embodiment, as shown in FIG. 3, when banknotes do not need to pass through the banknote recognition device 60, the banknotes can sequentially pass through the second intermediate channel 90 and the third channel 16 into the second channel 13, and then directly enter the banknote discharging channel 11. As shown in FIG. 2, when banknotes need to pass through the banknote recognition device 60, the banknotes can sequentially pass through the second intermediate channel 90 and the third channel 16 into the first channel 12. After being recognized by the banknote recognition device 60, banknotes pass through the first channel 12 into the banknote discharging channel 11. In this manner, the banknotes in the banknote box can be discharged through the two paths during the withdrawal operation of the cash recycling apparatus provided in this embodiment, satisfying the usage needs of the different users. Moreover, regardless of which discharging path is used, there is no waiting time between every two adjacent banknotes, resulting in high withdrawal efficiency.

Optionally, referring to FIG. 1, the cash recycling apparatus provided in this embodiment further includes a first direction switching member 53 and a second direction switching member 54, the multiple banknote boxes include a storage box 701 and a recycling box 702, and the lower conveying channel 30 includes a storage channel 61, a fourth channel 62, and a fifth channel 63. A first end of the storage channel 61 is connected to the storage box 701. A second end of the storage channel 61, a first end of the fourth channel 62, and a second end of the first intermediate channel 80 intersect at a fourth common junction point 37. The first direction switching member 53 is located at the fourth common junction point 37 and is configured to enable the first intermediate channel 80 to selectively communicate with one of the storage channel 61 and the fourth channel 62. A second end of the fourth channel 62, a first end of the fifth channel 63, and the second intermediate channel 90 intersect at a fifth common junction point 38. The second direction switching member 54 is located at the fifth common junction point 38 and is configured to enable the fifth channel 63 to selectively communicate with one of the second intermediate channel 90 and the fourth channel 62. The fifth channel 63 is connected to the recycling box 702 through a branch channel 64. In this embodiment, an exemplary solution is provided in which both the first direction switching member 53 and the second direction switching member 54 are provided. In this manner, during a withdrawal operation, as shown in FIGS. 2 and 3, the second direction switching member 54 communicates with the fifth channel 63 and the second intermediate channel 90 so that banknotes in the recycling box 702 can sequentially pass through the branch channel 64, the fifth channel 63, and the second intermediate channel 90 into the upper conveying channel 20, and enter the banknote discharging device 50 through the upper conveying channel 20. During a deposit operation, as shown in FIG. 4, when the banknotes need to enter the storage box 701, for example, when the banknote recognition device 60 recognizes the banknotes as large-denomination banknotes, the first direction switching member 53 communicates with the first intermediate channel 80 and the storage channel 61 so that the banknotes inserted through the banknote feeding device 40 sequentially pass through the upper conveying channel 20, the first intermediate channel 80, and the storage channel 61, and enter the storage box 701 for storage. Alternatively, during a deposit operation, when the banknote recognition device 60 recognizes that the banknotes need to enter the recycling box 702, for example, when the banknote recognition device 60 recognizes the banknotes as small-denomination banknotes, the first direction switching member 53 communicates with the first intermediate channel 80 and the fourth channel 62, and the second direction switching member 54 communicates with the fourth channel 62 and the fifth channel 63 so that the banknotes inserted through the banknote feeding device 40 sequentially pass through the upper conveying channel 20, the first intermediate channel 80, the fourth channel 62, the fifth channel 63, and the branch channel 64 into the recycling box 702. Alternatively, during a deposit operation, when the banknote recognition device 60 recognizes the banknotes as unqualified banknotes, for example, when the banknote recognition device 60 cannot recognize the banknotes, the banknotes inserted through the banknote feeding device 40 directly enter the banknote discharging device 50 through the upper conveying channel 20 and are returned to the user.

Optionally, referring to FIG. 1, the first direction switching member 53 is rotatably connected to the frame 10 and can rotate relative to the frame 10 and thus has position A3 and position B3. When located in position A3, the first direction switching member 53 communicates with the first intermediate channel 80 and the storage channel 61 while blocking the communication between the first intermediate channel 80 and the fourth channel 62. When located in position B3, the first direction switching member 53 communicates with the first intermediate channel 80 and the fourth channel 62 while blocking the communication between the first intermediate channel 80 and the storage channel 61. The second direction switching member 54 is rotatably connected to the frame 10 and can rotate relative to the frame 10 and thus has position A4 and position B4. When located in position A4, the second direction switching member 54 communicates with the fifth channel 63 and the second intermediate channel 90 while blocking the communication between the fifth channel 63 and the fourth channel 62. When located in position B4, the second direction switching member 54 communicates with the fifth channel 63 and the fourth channel 62 while blocking the communication between the fifth channel 63 and the second intermediate channel 90. During a deposit operation of the cash recycling apparatus provided in this embodiment, when the banknote recognition device 60 recognizes that the banknotes need to enter the storage box 701, the first direction switching member 53 is located in position A3; when the banknote recognition device 60 recognizes that the banknotes need to enter the recycling box 702, the first direction switching member 53 is located in position B3, and the second direction switching member 54 is located in position B4. In other embodiments, the first direction switching member 53 may be slidably connected to the frame 10, and the second direction switching member 54 may also be slidably connected to the frame 10.

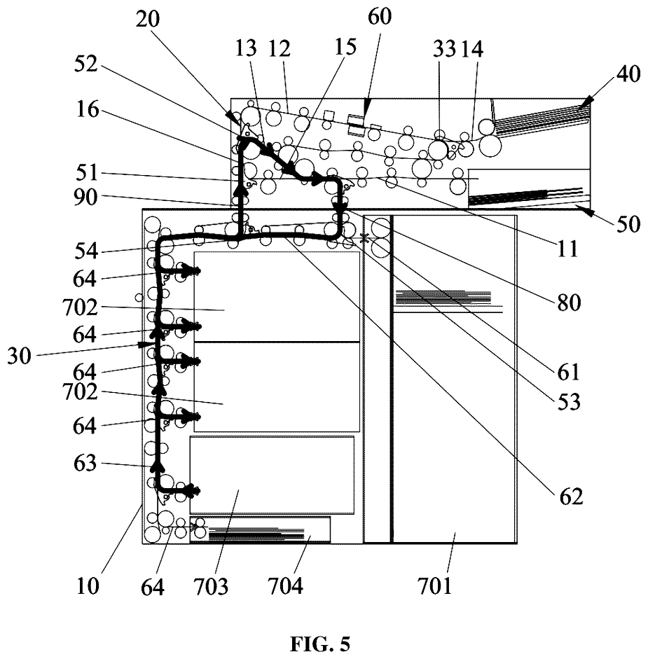

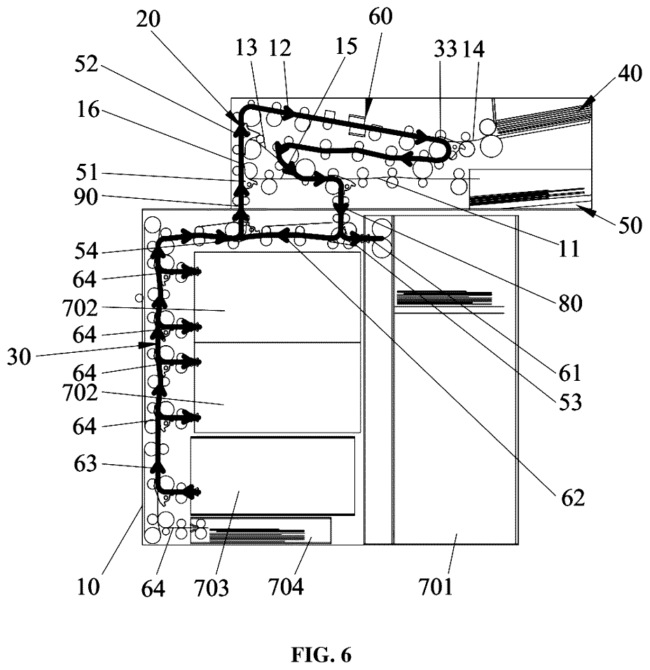

Optionally, referring to FIG. 1, the multiple banknote boxes include multiple recycling boxes 702 and further include a counterfeit-banknote box 704 and a loading box 703. The recycling boxes 702, the loading box 703, and the counterfeit-banknote box 704 are arranged sequentially in the vertical direction, and each of the recycling boxes 702, the loading box 703, and the counterfeit-banknote box 704 is connected to the fifth channel 63 through a respective branch channel 64. The storage box 701 and the recycling boxes 702 are arranged in the front-rear direction. In this manner, the structural compactness of the cash recycling apparatus can be enhanced. The loading box 703 is configured to store spare banknotes. The counterfeit-banknote box 704 is configured to receive counterfeit banknotes inserted from the banknote feeding device 40 during a deposit operation. The recycling boxes 702 are configured to receive banknotes inserted from the banknote feeding device 40 during a deposit operation and discharge banknotes during a withdrawal operation. The storage box 701 is disposed in front of the recycling boxes 702 and is configured to receive large-denomination banknotes deposited during a deposit operation and receive abnormal banknotes recognized by the banknote recognition device 60 during withdrawal and loading operations, and receive banknotes discharged from the recycling boxes 702 during a clearing operation. During a loading operation of the cash recycling apparatus provided in this embodiment, if the banknotes stored in the loading box 703 are banknotes of a single denomination, as shown in FIG. 5, the banknotes in the loading box 703 can enter the fifth channel 63 through a corresponding branch channel 64, and sequentially pass through the second intermediate channel 90, the third channel 16, the second channel 13, the banknote discharging channel 11, the first intermediate channel 80, the fourth channel 62, the fifth channel 63, and corresponding branch channels 64 into the recycling boxes 702. If the banknotes stored in the loading box 703 are banknotes of mixed denominations, for example, when the loading box 703 stores banknotes of three denominations, namely, 10 yuan, 50 yuan, and 100 yuan, as shown in FIG. 6, the banknotes in the loading box 703 can enter the fifth channel 63 through the corresponding branch channel 64, and sequentially pass through the second intermediate channel 90, the third channel 16, and the first channel 12 into the banknote recognition device 60. Qualified banknotes recognized by the banknote recognition device 60 sequentially pass through the first channel 12, the banknote discharging channel 11, the first intermediate channel 80, the fourth channel 62, the fifth channel 63, and the corresponding branch channels 64 into the recycling boxes 702. Unqualified banknotes recognized by the banknote recognition device 60 sequentially pass through the first channel 12, the banknote discharging channel 11, the first intermediate channel 80, and the storage channel 61 into the storage box 701. The loading box 703 of the cash recycling apparatus provided in this embodiment can not only store banknotes of a single denomination but also banknotes of multiple denominations, thereby satisfying usage needs under different circumstances.

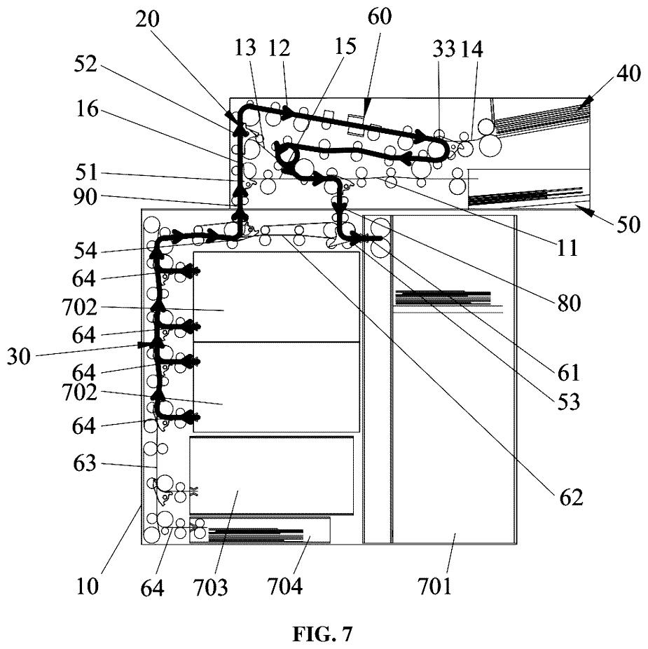

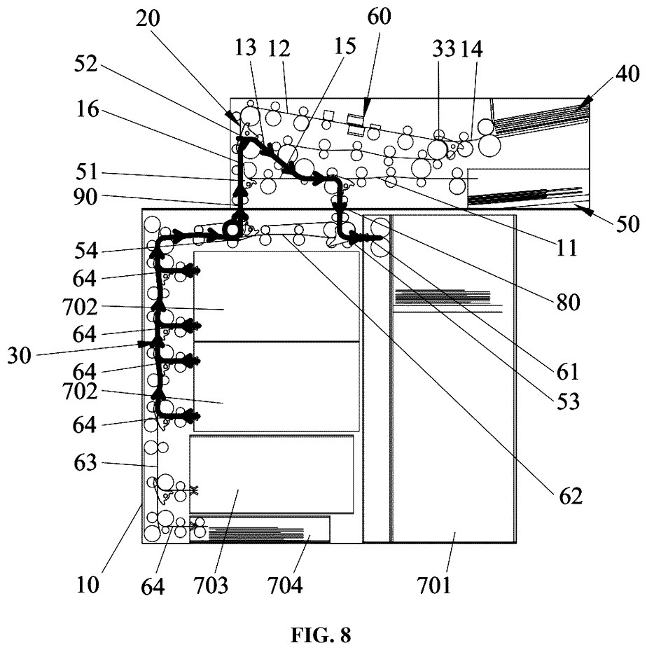

During a clearing operation, when it is necessary to recognize the banknotes stored in the recycling boxes 702, for example, to recognize denominations of the banknotes and count the number of banknotes of each denomination, as shown in FIG. 7, the banknotes in the recycling boxes 702 sequentially pass through the corresponding branch channels 64, the fifth channel 63, the second intermediate channel 90, the third channel 16, and the first channel 12 into the banknote recognition device 60. After being recognized by the banknote recognition device 60, banknotes sequentially pass through the first channel 12, the banknote discharging channel 11, the first intermediate channel 80, and the storage channel 61 into the storage box 701. When it is unnecessary to recognize the banknotes in the recycling boxes 702, as shown in FIG. 8, the banknotes in the recycling boxes 702 sequentially pass through the corresponding branch channels 64, the fifth channel 63, the second intermediate channel 90, the third channel 16, the second channel 13, the banknote discharging channel 11, the first intermediate channel 80, and the storage channel 61 into the storage box 701. The cash recycling apparatus provided in this embodiment can satisfy both requirements of recognizing and not recognizing the banknotes during the clearing operation, while ensuring operating efficiency in the case where the requirements are satisfied.

Embodiment one further provides a banknote processing method. The banknote processing method is performed by the preceding cash recycling apparatus. The upper conveying channel 20 of the cash recycling apparatus includes the banknote discharging channel 11, the first channel 12, the second channel 13, the transition channel 15, and the third channel 16. The multiple banknote boxes include the recycling boxes 702 and the storage box 701.

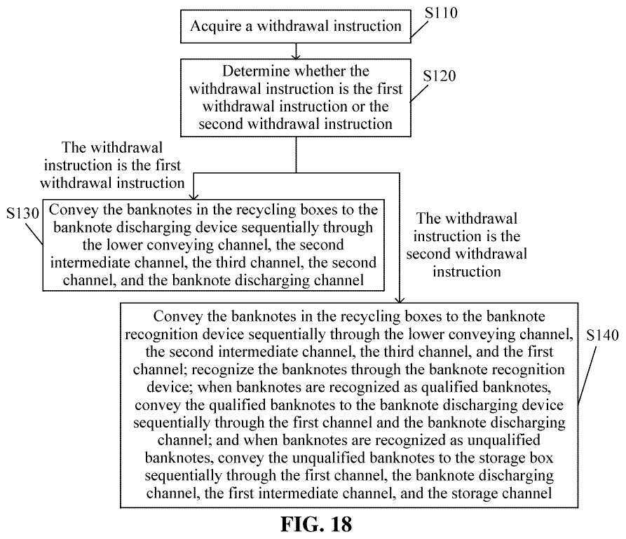

Referring to FIG. 18, the banknote processing method includes the steps below.

In S110, a withdrawal instruction is acquired.

The withdrawal instruction includes a first withdrawal instruction and a second withdrawal instruction. The cash recycling apparatus may be provided with a first button for triggering the first withdrawal instruction and a second button for triggering the second withdrawal instruction. The user may choose a specific withdrawal instruction through the first button and the second button.

In S120, whether the withdrawal instruction is the first withdrawal instruction or the second withdrawal instruction is determined.

If the withdrawal instruction is the first withdrawal instruction, S130 is executed; if the withdrawal instruction is the second withdrawal instruction, S140 is executed.

In S130, a first withdrawal operation is performed. As shown in FIG. 3, the first withdrawal operation includes: conveying the banknotes in the recycling boxes 702 to the banknote discharging device 50 sequentially through the lower conveying channel 30, the second intermediate channel 90, the third channel 16, the second channel 13, and the banknote discharging channel 11.

In S140, a second withdrawal operation is performed. As shown in FIG. 2, the second withdrawal operation includes: conveying the banknotes in the recycling boxes 702 to the banknote recognition device 60 sequentially through the lower conveying channel 30, the second intermediate channel 90, the third channel 16, and the first channel 12; recognizing the banknotes through the banknote recognition device 60; when banknotes are recognized as qualified banknotes, conveying the qualified banknotes to the banknote discharging device 50 sequentially through the first channel 12 and the banknote discharging channel 11; and when banknotes are recognized as unqualified banknotes, conveying the unqualified banknotes to the storage box 701 sequentially through the first channel 12, the banknote discharging channel 11, the first intermediate channel 80, and the lower conveying channel 30.

In the banknote processing method, during a withdrawal operation, two operation modes can be selected: one in which the banknotes pass through the banknote recognition device 60 for recognition and the other one in which the banknotes bypass the banknote recognition device 60, thereby satisfying the usage needs of the different users.

### Embodiment Two

This embodiment provides a cash recycling apparatus. The cash recycling apparatus differs from the cash recycling apparatus provided in embodiment one in that, in the preceding embodiment, the second end of the transition channel 15 and the first end of the first intermediate channel 80 both intersect with the banknote discharging channel 11 (as shown in FIG. 20), but, in this embodiment, the second end of the transition channel 15 and the first end of the first intermediate channel 80 both intersect with the second channel 13 (as shown in FIG. 21). This is described in detail below.

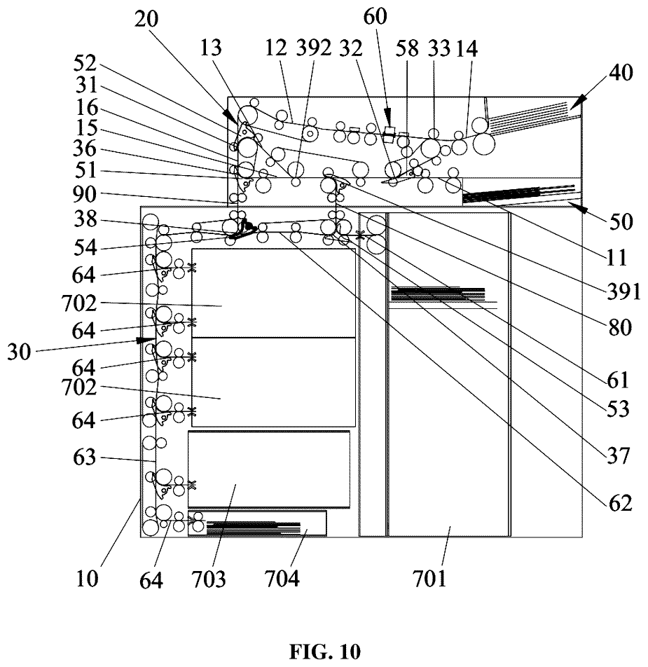

FIG. 10 is a diagram illustrating the structure of a cash recycling apparatus according to embodiment two of the present application. FIG. 21 is a diagram illustrating the layout of channels in a cash recycling apparatus according to embodiment two of the present application. Referring to FIGS. 10 and 21, in the cash recycling apparatus, the first end of the first intermediate channel 80 and the second channel 13 intersect at a fourth connection point 391; the first end of the transition channel 15, the first end of the third channel 16, and the second intermediate channel 90 intersect at the third common junction point 36; the second end of the transition channel 15 and the second channel 13 intersect at a fifth connection point 392; the fifth connection point 392 is located between the first end of the second channel 13 and the fourth connection point 391.

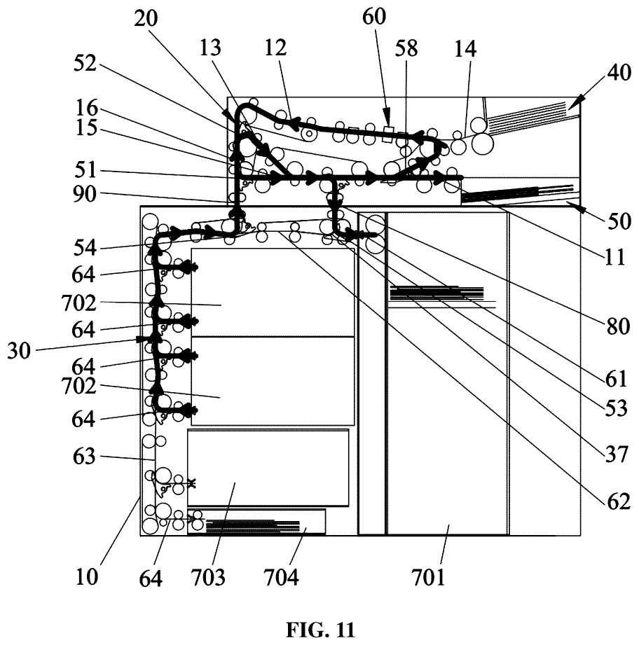

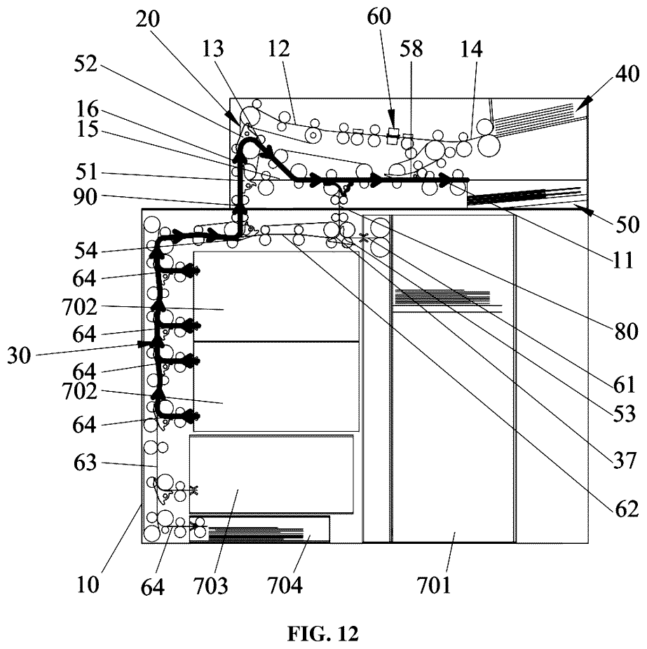

During a withdrawal operation of the cash recycling apparatus provided in this embodiment, if the banknotes need to be recognized through the banknote recognition device 60, as shown in FIG. 11, the banknotes in the recycling boxes 702 can sequentially pass through the lower conveying channel 30, the second intermediate channel 90, the third channel 16, and the second channel 13 into the first channel 12; the banknotes are recognized through the banknote recognition device 60 in the first channel 12; the qualified banknotes recognized through the banknote recognition device 60 sequentially pass through the first channel 12, the third channel 16, the transition channel 15, and the second channel 13 into the banknote discharging channel 11, and then enter the banknote discharging device 50; the unqualified banknotes recognized by the banknote recognition device 60 sequentially pass through the first channel 12, the third channel 16, the transition channel 15, and the second channel 13 into the first intermediate channel 80, and then enter the storage box 701 through the storage channel 61 in the lower conveying channel 30. If the banknotes do not need to be recognized through the banknote recognition device 60, as shown in FIG. 12, the banknotes in the recycling boxes 702 can sequentially pass through the lower conveying channel 30, the second intermediate channel 90, the third channel 16, and the second channel 13 into the banknote discharging channel 11, and then enter the banknote discharging device 50 through the banknote discharging channel 11.

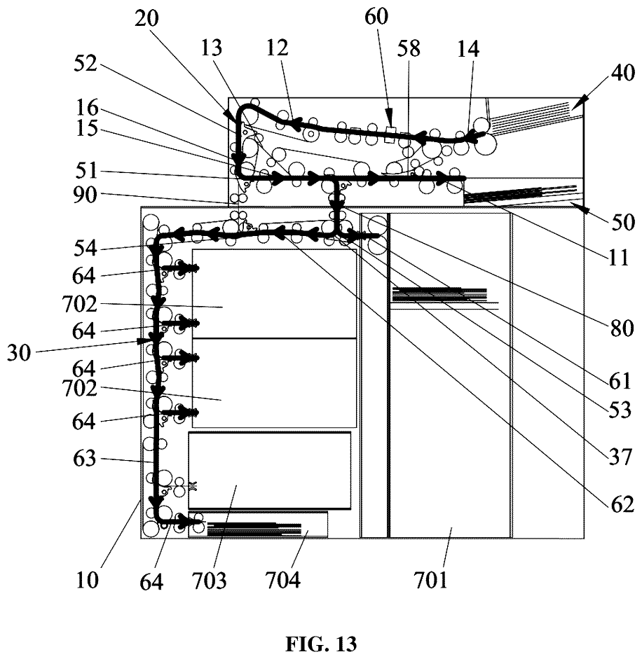

During a deposit operation of the cash recycling apparatus provided in this embodiment, as shown in FIG. 13, the banknotes can enter the first channel 12 through the banknote feeding channel 14. The banknotes are recognized through the banknote recognition device 60 in the first channel 12. The qualified banknotes recognized by the banknote recognition device 60 sequentially pass through the first channel 12, the third channel 16, the transition channel 15, the second channel 13, the first intermediate channel 80, and the lower conveying channel 30 into the banknote boxes. The unqualified banknotes recognized by the banknote recognition device 60 sequentially pass through the first channel 12, the third channel 16, the transition channel 15, the second channel 13, and the banknote discharging channel 11 into the banknote discharging device 50, and are returned to the user.

The provision of the transition channel 15 in the cash recycling apparatus provided in this embodiment can reduce the commutation complexity at the first common junction point 31, lower the risk of a banknote jam at the first common junction point 31, and ensure that the directions in which banknotes pass through the banknote recognition device 60 are the same during both deposit and withdrawal operations, thereby enhancing the recognition accuracy of the banknote recognition device 60.

Optionally, referring to FIGS. 10 to 17, in this embodiment, the cash recycling apparatus further includes a third commutator 58. The third commutator 58 is disposed at the second common junction point 32 and is configured to enable the second channel 13 to selectively communicate with one of the first channel 12 and the banknote discharging channel 11. In this embodiment, an exemplary solution is provided in which the first commutator 51, the second commutator 52, and the third commutator 58 are provided. In other embodiments, one or two of the first commutator 51, the second commutator 52, and the third commutator 58 may be provided as needed.

Optionally, referring to FIGS. 10 to 17, the third commutator 58 is rotatably connected to the frame 10 and can rotate relative to the frame 10 and thus has position A5 and position B5. When located in position A5, the third commutator 58 communicates with the second channel 13 and the first channel 12 while blocking the communication between the second channel 13 and the banknote discharging channel 11. When located in position B5, the third commutator 58 communicates with the second channel 13 and the banknote discharging channel 11 while blocking the communication between the second channel 13 and the first channel 12. When the banknotes do not pass through the banknote recognition device 60 during a withdrawal operation of the cash recycling apparatus provided in this embodiment, as shown in FIG. 12, the third commutator 58 is located in position B5 so that the banknotes can enter the banknote discharging channel 11 through the second channel 13 and enter the banknote discharging device 50 through the banknote discharging channel 11. When the banknotes pass through the banknote recognition device 60 during a withdrawal operation of the cash recycling apparatus provided in this embodiment, as shown in FIG. 11, the third commutator 58 is first located in position A5 so that the banknotes can enter the first channel 12 through the second channel 13; when the banknote recognition device 60 recognizes banknotes as qualified banknotes, the third commutator 58 is located in position B5 so that the banknotes enter the banknote discharging channel 11 through the second channel 13 and enter the banknote discharging device 50 through the banknote discharging channel 11.

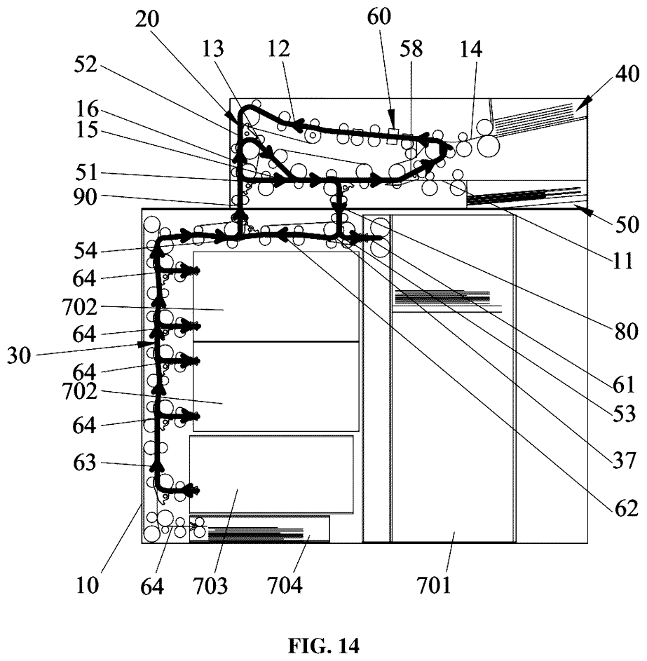

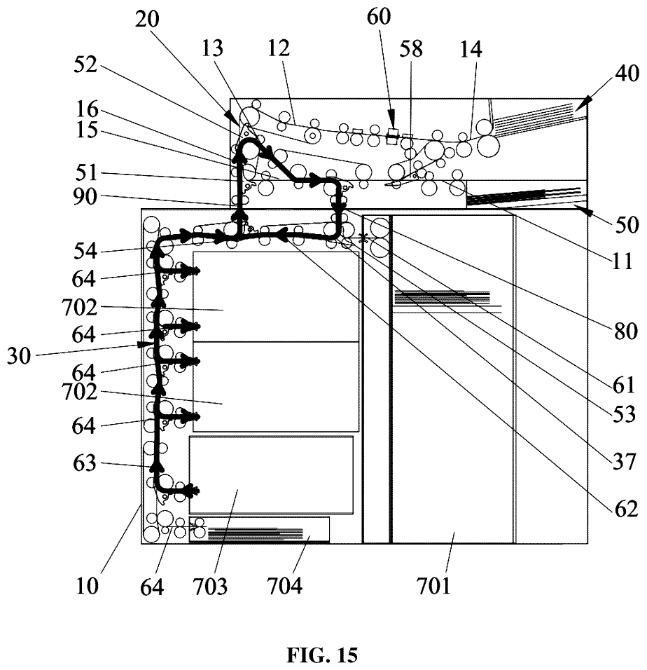

Optionally, the structure of the lower conveying channel 30 in embodiment two is the same as that of the lower conveying channel 30 in embodiment 1 described in the preceding. During a loading operation of the cash recycling apparatus provided in this embodiment, if the banknotes in the loading box 703 are banknotes of multiple denominations, as shown in FIG. 14, the banknotes in the loading box 703 can pass through a corresponding branch channel 64 into the fifth channel 63, and sequentially pass through the second intermediate channel 90, the third channel 16, the second channel 13, and the first channel 12 into the banknote recognition device 60; the qualified banknotes recognized by the banknote recognition device 60 sequentially pass through the first channel 12, the third channel 16, the transition channel 15, the second channel 13, the first intermediate channel 80, the fourth channel 62, the fifth channel 63, and the corresponding branch channels 64 into the recycling boxes 702; the unqualified banknotes recognized by the banknote recognition device 60 sequentially pass through the first channel 12, the third channel 16, the transition channel 15, the second channel 13, the first intermediate channel 80, and the storage channel 61 into the storage box 701. If the banknotes in the loading box 703 are banknotes of a single denomination, as shown in FIG. 15, the banknotes in the loading box 703 can pass through the corresponding branch channel 64 into the fifth channel 63, and sequentially pass through the second intermediate channel 90, the third channel 16, the second channel 13, the first intermediate channel 80, the fourth channel 62, the fifth channel 63, and the corresponding branch channels 64 into the recycling boxes 702.

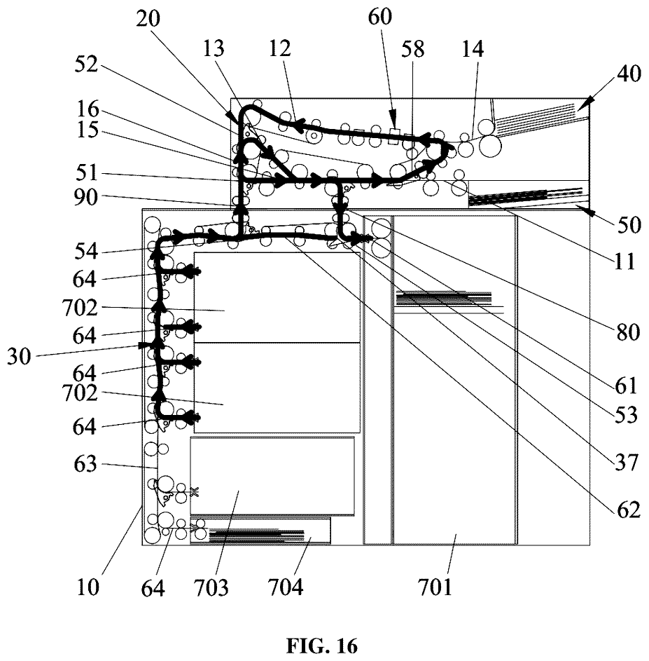

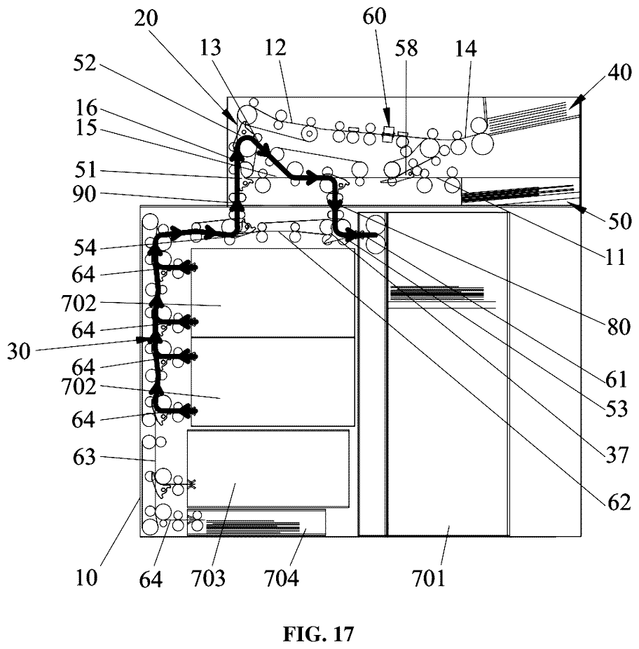

During a clearing operation of the cash recycling apparatus provided in this embodiment, when it is necessary to recognize the banknotes, as shown in FIG. 16, the banknotes in the recycling boxes 702 sequentially pass through the corresponding branch channels 64, the fifth channel 63, the second intermediate channel 90, the third channel 16, the second channel 13, and the first channel 12 into the banknote recognition device 60. After being recognized through the banknote recognition device 60, banknotes sequentially pass through the first channel 12, the third channel 16, the transition channel 15, the second channel 13, the first intermediate channel 80, and the storage channel 61 into the storage box 701. When it is unnecessary to recognize the banknotes, as shown in FIG. 17, the banknotes in the recycling boxes 702 sequentially pass through the corresponding branch channels 64, the fifth channel 63, the second intermediate channel 90, the third channel 16, the second channel 13, the first intermediate channel 80, and the storage channel 61 into the storage box 701.

Embodiment two further provides a banknote processing method. The banknote processing method is performed by the cash recycling apparatus provided in embodiment two. The upper conveying channel 20 of the cash recycling apparatus includes the banknote discharging channel 11, the first channel 12, the second channel 13, the transition channel 15, the third channel 16, and the banknote feeding channel 14. The multiple banknote boxes include the recycling boxes 702 and the storage box 701.

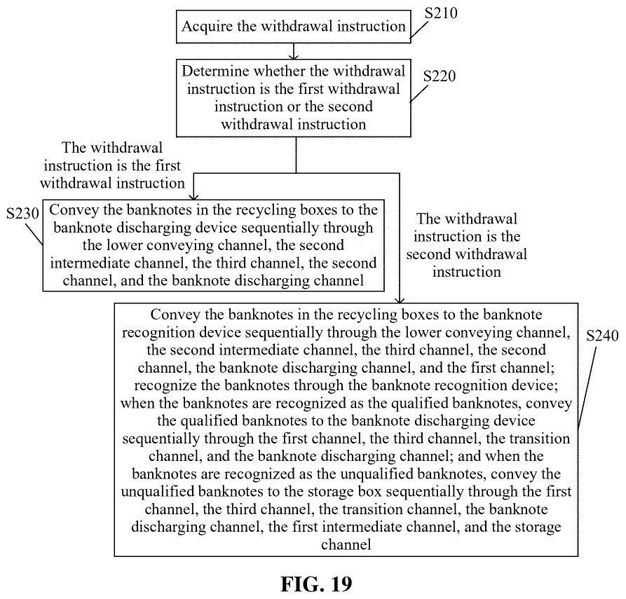

Referring to FIG. 19, the banknote processing method includes the steps below.

In S210, the withdrawal instruction is acquired.

The withdrawal instruction includes the first withdrawal instruction and the second withdrawal instruction. The cash recycling apparatus may be provided with the first button for triggering the first withdrawal instruction and the second button for triggering the second withdrawal instruction. The user may choose the specific withdrawal instruction through the first button and the second button.

In S220, whether the withdrawal instruction is the first withdrawal instruction or the second withdrawal instruction is determined.

If the withdrawal instruction is the first withdrawal instruction, S230 is executed; if the withdrawal instruction is the second withdrawal instruction, S240 is executed.

In S230, the first withdrawal operation is performed. As shown in FIG. 12, the banknotes in the recycling boxes 702 are conveyed to the banknote discharging device 50 sequentially through the lower conveying channel 30, the second intermediate channel 90, the third channel 16, the second channel 13, and the banknote discharging channel 11.

In S240, the second withdrawal operation is performed. As shown in FIG. 11, the banknotes in the recycling boxes 702 are conveyed to the banknote recognition device 60 sequentially through the lower conveying channel 30, the second intermediate channel 90, the third channel 16, the second channel 13, and the first channel 12; the banknote recognition device 60 recognizes the banknotes; when the banknotes are recognized as the qualified banknotes, the qualified banknotes are conveyed to the banknote discharging device 50 sequentially through the first channel 12, the third channel 16, the transition channel 15, the second channel 13, and the banknote discharging channel 11; and when the banknotes are recognized as the unqualified banknotes, the unqualified banknotes are conveyed to the storage box 701 sequentially through the first channel 12, the third channel 16, the transition channel 15, the second channel 13, the first intermediate channel 80, and the lower conveying channel 30.

In the banknote processing method, during the withdrawal operation, the two operation modes can be selected: one in which the banknotes pass through the banknote recognition device 60 for recognition and the other one in which the banknotes bypass the banknote recognition device 60, thereby satisfying the usage needs of the different users.

1. A cash recycling apparatus, comprising an upper conveying channel, a lower conveying channel, a banknote feeding device, a banknote discharging device, a banknote recognition device, a plurality of banknote boxes, a first intermediate channel and a second intermediate channel,
wherein the banknote feeding device and the banknote discharging device are connected to the upper conveying channel, the banknote feeding device is configured to input banknotes into the upper conveying channel, the banknote discharging device is configured to receive banknotes output from the upper conveying channel, the banknote recognition device is disposed on the upper conveying channel and is configured to acquire information about banknotes in the upper conveying channel, and each of the plurality of banknote boxes is connected to the lower conveying channel; and
wherein the first intermediate channel and the second intermediate channel are independent of each other and are both connected between the upper conveying channel and the lower conveying channel, the first intermediate channel is configured to convey banknotes from the upper conveying channel to the lower conveying channel, and the second intermediate channel is configured to convey banknotes from the lower conveying channel to the upper conveying channel.

2. The cash recycling apparatus according to claim 1, wherein the upper conveying channel comprises a banknote discharging channel, a first channel, and a second channel, wherein the banknote discharging channel communicates with the banknote discharging device and is configured to selectively communicate with one of the first channel and the second channel the second intermediate channel is configured to selectively communicate with one of the first channel and the second channel and the banknote recognition device is disposed on the first channel.

3. The cash recycling apparatus according to claim 2, wherein the upper conveying channel further comprises a third channel, wherein a first end of the third channel is connected to the second intermediate channel, a first end of the first channel, a first end of the second channel, and a second end of the third channel intersect at a first common junction point a second end of the first channel, a second end of the second channel, and a first end of the banknote discharging channel intersect at a second common junction point and a second end of the banknote discharging channel is connected to the banknote discharging device.

4. The cash recycling apparatus according to claim 3, wherein the upper conveying channel further comprises a banknote feeding channel, wherein a first end of the banknote feeding channel is connected to the banknote feeding device, a second end of the banknote feeding channel and the first channel intersect at a first connection point and the banknote recognition device is located between the first connection point and the first end of the first channel;
the first intermediate channel and the banknote discharging channel intersect at a second connection point; and
the upper conveying channel further comprises a transition channel, wherein a first end of the transition channel, the first end of the third channel, and the second intermediate channel intersect at a third common junction point, a second end of the transition channel and the banknote discharging channel intersect at a third connection point, and the third connection point is located between the first end of the banknote discharging channel and the second connection point.

5. The cash recycling apparatus according to claim 3, wherein the upper conveying channel further comprises a first roller, a second roller, and at least one third roller, wherein the second roller is disposed at the second common junction point, each of the at least one third roller is disposed on the first channel, the first roller tangentially engages with each of the at least one third roller, the first roller tangentially engages with the second roller, the first roller and each of the at least one third roller are configured to convey banknotes in the first channel to the banknote discharging channel, the first roller and the second roller are configured to convey banknotes in the first channel to the banknote discharging channel, and the first roller and the second roller are further configured to convey banknotes in the second channel to the banknote discharging channel.

6. The cash recycling apparatus according to claim 3, wherein the upper conveying channel further comprises a banknote feeding channel, wherein a first end of the banknote feeding channel is connected to the banknote feeding device, a second end of the banknote feeding channel and the first channel intersect at a first connection point and the banknote recognition device is located between the first connection point and the first end of the first channel;
the first intermediate channel and the second channel intersect at a fourth connection point; and
the upper conveying channel further comprises a transition channel, wherein a first end of the transition channel, the first end of the third channel, and the second intermediate channel intersect at a third common junction point, a second end of the transition channel and the second channel intersect at a fifth connection point, and the fifth connection point is located between the first end of the second channel and the fourth connection point.

7. The cash recycling apparatus according to claim 6, further comprising a first commutator, wherein the first commutator is disposed at the third common junction point, and the first commutator is configured to enable the third channel to selectively communicate with one of the transition channel and the second intermediate channel.

8. The cash recycling apparatus according to claim 6, further comprising a second commutator, wherein the second commutator is disposed at the first common junction point, and the second commutator is configured to enable the third channel to selectively communicate with one of the first channel and the second channel.

9. The cash recycling apparatus according to claim 6, further comprising a third commutator, wherein the third commutator is disposed at the second common junction point, and the third commutator is configured to enable the second channel to selectively communicate with one of the first channel and the banknote discharging channel.

10. The cash recycling apparatus according to claim 1, further comprising a first direction switching member and a second direction switching member, wherein the plurality of banknote boxes comprise a storage box and a recycling box, and the lower conveying channel comprises a storage channel a fourth channel and a fifth channel;
wherein a first end of the storage channel is connected to the storage box, a second end of the storage channel, a first end of the fourth channel, and the first intermediate channel intersect at the fourth common junction point, the first direction switching member is located at the fourth common junction point, and the first direction switching member is configured to enable the first intermediate channel to selectively communicate with one of the storage channel and the fourth channel; and
wherein a second end of the fourth channel, a first end of the fifth channel, and the second intermediate channel intersect at the fifth common junction point, the second direction switching member is located at the fifth common junction point the second direction switching member is configured to enable the fifth channel to selectively communicate with one of the second intermediate channel and the fourth channel, and the fifth channel is connected to the recycling box through a branch channel.

11. A banknote processing method, applied to a cash recycling apparatus, wherein the cash recycling apparatus comprises an upper conveying channel, a lower conveying channel, a banknote feeding device, a banknote discharging device, a banknote recognition device, a plurality of banknote boxes, a first intermediate channel, and a second intermediate channel,
wherein the banknote feeding device and the banknote discharging device are connected to the upper conveying channel, the banknote feeding device is configured to input banknotes into the upper conveying channel, the banknote discharging device is configured to receive banknotes output from the upper conveying channel, the banknote recognition device is disposed on the upper conveying channel and is configured to acquire information about banknotes in the upper conveying channel, and each of the plurality of banknote boxes is connected to the lower conveying channel; and
wherein the first intermediate channel and the second intermediate channel are independent of each other and are both connected between the upper conveying channel and the lower conveying channel, the first intermediate channel is configured to convey banknotes from the upper conveying channel to the lower conveying channel. and the second intermediate channel is configured to convey banknotes from the lower conveying channel to the upper conveying channel;
wherein the upper conveying channel comprises a banknote discharging channel, a first channel, and a second channel, wherein the banknote discharging channel communicates with the banknote discharging device and is configured to selectively communicate with one of the first channel and the second channel, the second intermediate channel is configured to selectively communicate with one of the first channel and the second channel, and the banknote recognition device is disposed on the first channel;
wherein the upper conveying channel further comprises a third channel, wherein a first end of the third channel is connected to the second intermediate channel, a first end of the first channel, a first end of the second channel, and a second end of the third channel intersect at a first common junction point, a second end of the first channel, a second end of the second channel, and a first end of the banknote discharging channel intersect at a second common junction point, and a second end of the banknote discharging channel is connected to the banknote discharging device;
the banknote processing method comprising:
acquiring a withdrawal instruction, wherein the withdrawal instruction comprises a first withdrawal instruction and a second withdrawal instruction; and
performing a first withdrawal operation in a case where the withdrawal instruction is the first withdrawal instruction; and performing a second withdrawal operation in a case where the withdrawal instruction is the second withdrawal instruction,
wherein the first withdrawal operation comprises: conveying banknotes in a recycling box among the plurality of banknote boxes to the banknote discharging device sequentially through the lower conveying channel, the second intermediate channel, the third channel, the second channel, and the banknote discharging channel; and
wherein the second withdrawal operation comprises: conveying banknotes in the recycling box to the banknote recognition device sequentially through the lower conveying channel, the second intermediate channel, the third channel, and the first channel; recognizing banknotes through the banknote recognition device; in a case where banknotes are recognized as qualified banknotes, conveying the qualified banknotes to the banknote discharging device sequentially through the first channel and the banknote discharging channel; and in a case where banknotes are recognized as unqualified banknotes, conveying the unqualified banknotes to a storage box among the plurality of banknote boxes sequentially through the first channel, the banknote discharging channel, the first intermediate channel, and the lower conveying channel.

12. A banknote processing method, applied to a cash recycling apparatus, wherein the cash recycling apparatus comprises an upper conveying channel, a lower conveying channel, a banknote feeding device, a banknote discharging device, a banknote recognition device, a plurality of banknote boxes, a first intermediate channel, and a second intermediate channel,
wherein the banknote feeding device and the banknote discharging device are connected to the upper conveying channel, the banknote feeding device is configured to input banknotes into the upper conveying channel, the banknote discharging device is configured to receive banknotes output from the upper conveying channel, the banknote recognition device is disposed on the upper conveying channel and is configured to acquire information about banknotes in the upper conveying channel, and each of the plurality of banknote boxes is connected to the lower conveying channel; and
wherein the first intermediate channel and the second intermediate channel are independent of each other and are both connected between the upper conveying channel and the lower conveying channel, the first intermediate channel is configured to convey banknotes from the upper conveying channel to the lower conveying channel, and the second intermediate channel is configured to convey banknotes from the lower conveying channel to the upper conveying channel;
wherein the upper conveying channel comprises a banknote discharging channel, a first channel, and a second channel, wherein the banknote discharging channel communicates with the banknote discharging device and is configured to selectively communicate with one of the first channel and the second channel, the second intermediate channel is configured to selectively communicate with one of the first channel and the second channel, and the banknote recognition device is disposed on the first channel;
wherein the upper conveying channel further comprises a third channel, wherein a first end of the third channel is connected to the second intermediate channel, a first end of the first channel, a first end of the second channel, and a second end of the third channel intersect at a first common junction point, a second end of the first channel, a second end of the second channel, and a first end of the banknote discharging channel intersect at a second common junction point, and a second end of the banknote discharging channel is connected to the banknote discharging device;
wherein the upper conveying channel further comprises a banknote feeding channel, wherein a first end of the banknote feeding channel is connected to the banknote feeding device, a second end of the banknote feeding channel and the first channel intersect at a first connection point, and the banknote recognition device is located between the first connection point and the first end of the first channel;
the first intermediate channel and the second channel intersect at a fourth connection point; and
the upper conveying channel further comprises a transition channel, wherein a first end of the transition channel, the first end of the third channel, and the second intermediate channel intersect at a third common junction point, a second end of the transition channel and the second channel intersect at a fifth connection point, and the fifth connection point is located between the first end of the second channel and the fourth connection point;
the banknote processing method comprising:
acquiring a withdrawal instruction, wherein the withdrawal instruction comprises a first withdrawal instruction and a second withdrawal instruction; and
performing a first withdrawal operation in a case where the withdrawal instruction is the first withdrawal instruction; and performing a second withdrawal operation in a case where the withdrawal instruction is the second withdrawal instruction,
wherein the first withdrawal operation comprises: conveying banknotes in a recycling box among the plurality of banknote boxes to the banknote discharging device sequentially through the lower conveying channel, the second intermediate channel, the third channel the second channel and the banknote discharging channel; and
wherein the second withdrawal operation comprises: conveying banknotes in the recycling box to the banknote recognition device sequentially through the lower conveying channel, the second intermediate channel, the third channel, the second channel, and the first channel; recognizing banknotes through the banknote recognition device; in a case where banknotes are recognized as qualified banknotes, conveying the qualified banknotes to the banknote discharging device sequentially through the first channel, the third channel, the transition channel, the second channel, and the banknote discharging channel; and in a case where banknotes are recognized as unqualified banknotes, conveying the unqualified banknotes to a storage box among the plurality of banknote boxes sequentially through the first channel, the third channel, the transition channel, the second channel the first intermediate channel, and the lower conveying channel.

13. The cash recycling apparatus according to claim 7, further comprising a second commutator, wherein the second commutator is disposed at the first common junction point, and the second commutator is configured to enable the third channel to selectively communicate with one of the first channel and the second channel.

14. The cash recycling apparatus according to claim 7, further comprising a third commutator, wherein the third commutator is disposed at the second common junction point, and the third commutator is configured to enable the second channel to selectively communicate with one of the first channel and the banknote discharging channel.

15. The cash recycling apparatus according to claim 8, further comprising a third commutator, wherein the third commutator is disposed at the second common junction point, and the third commutator is configured to enable the second channel to selectively communicate with one of the first channel and the banknote discharging channel.

16. The cash recycling apparatus according to claim 13, further comprising a third commutator, wherein the third commutator is disposed at the second common junction point, and the third commutator is configured to enable the second channel to selectively communicate with one of the first channel and the banknote discharging channel.

17. The cash recycling apparatus according to claim 2, further comprising a first direction switching member and a second direction switching member, wherein the plurality of banknote boxes comprise a storage box and a recycling box, and the lower conveying channel comprises a storage channel, a fourth channel, and a fifth channel;
wherein a first end of the storage channel is connected to the storage box, a second end of the storage channel, a first end of the fourth channel, and the first intermediate channel intersect at the fourth common junction point, the first direction switching member is located at the fourth common junction point, and the first direction switching member is configured to enable the first intermediate channel to selectively communicate with one of the storage channel and the fourth channel; and
wherein a second end of the fourth channel, a first end of the fifth channel, and the second intermediate channel intersect at the fifth common junction point, the second direction switching member is located at the fifth common junction point, the second direction switching member is configured to enable the fifth channel to selectively communicate with one of the second intermediate channel and the fourth channel, and the fifth channel is connected to the recycling box through a branch channel.

18. The cash recycling apparatus according to claim 3, further comprising a first direction switching member and a second direction switching member, wherein the plurality of banknote boxes comprise a storage box and a recycling box, and the lower conveying channel comprises a storage channel, a fourth channel, and a fifth channel;
wherein a first end of the storage channel is connected to the storage box, a second end of the storage channel, a first end of the fourth channel, and the first intermediate channel intersect at the fourth common junction point, the first direction switching member is located at the fourth common junction point, and the first direction switching member is configured to enable the first intermediate channel to selectively communicate with one of the storage channel and the fourth channel; and
wherein a second end of the fourth channel, a first end of the fifth channel, and the second intermediate channel intersect at the fifth common junction point, the second direction switching member is located at the fifth common junction point, the second direction switching member is configured to enable the fifth channel to selectively communicate with one of the second intermediate channel and the fourth channel, and the fifth channel is connected to the recycling box through a branch channel.

19. The cash recycling apparatus according to claim 4, further comprising a first direction switching member and a second direction switching member, wherein the plurality of banknote boxes comprise a storage box and a recycling box, and the lower conveying channel comprises a storage channel, a fourth channel, and a fifth channel;
wherein a first end of the storage channel is connected to the storage box, a second end of the storage channel, a first end of the fourth channel, and the first intermediate channel intersect at the fourth common junction point, the first direction switching member is located at the fourth common junction point, and the first direction switching member is configured to enable the first intermediate channel to selectively communicate with one of the storage channel and the fourth channel; and
wherein a second end of the fourth channel, a first end of the fifth channel, and the second intermediate channel intersect at the fifth common junction point, the second direction switching member is located at the fifth common junction point, the second direction switching member is configured to enable the fifth channel to selectively communicate with one of the second intermediate channel and the fourth channel, and the fifth channel is connected to the recycling box through a branch channel.

20. The cash recycling apparatus according to claim 5, further comprising a first direction switching member and a second direction switching member, wherein the plurality of banknote boxes comprise a storage box and a recycling box, and the lower conveying channel comprises a storage channel, a fourth channel, and a fifth channel;
wherein a first end of the storage channel is connected to the storage box, a second end of the storage channel, a first end of the fourth channel, and the first intermediate channel intersect at the fourth common junction point, the first direction switching member is located at the fourth common junction point, and the first direction switching member is configured to enable the first intermediate channel to selectively communicate with one of the storage channel and the fourth channel; and
wherein a second end of the fourth channel, a first end of the fifth channel, and the second intermediate channel intersect at the fifth common junction point, the second direction switching member is located at the fifth common junction point, the second direction switching member is configured to enable the fifth channel to selectively communicate with one of the second intermediate channel and the fourth channel, and the fifth channel is connected to the recycling box through a branch channel.
